(19) United States
(12) Patent Application Publication
(10) Pub. No.: US 2025/0203374 A1
(43) Pub. Date: Jun. 19, 2025

(54) METHOD AND SYSTEM FOR RFID-BASED PROTECTION OF COMPUTING DEVICE

(71) Applicant: PHILIPPE LORSON, Davie, FL (US)

(72) Inventor: PHILIPPE LORSON, Davie, FL (US)

(21) Appl. No.: 18/980,492

(22) Filed: Dec. 13, 2024

Related U.S. Application Data
(60) Provisional application No. 63/611,243, filed on Dec. 18, 2023.

(51) Int. Cl. H04W 12/47; G06K 7/10; H04W 12/041

(52) U.S. Cl. CPC H04W 12/47; G06K 7/10287; H04W 12/041

(57) ABSTRACT

A system for real-time monitoring and managing access to a computing device including a processor of a target computing device (TCD) configured to host an integrated RFID module and connected to an RFID database and a memory on which are stored machine-readable instructions that when executed by the processor, cause the processor to: detect a user RFID tag by the integrated RFID module; derive a user RFID from a signal between the user RFID tag and the integrated RFID module; compare the RFID to the RFID database containing at least one RFID registered for an access to the TCD; and responsive to a match of the user RFID with the at least one RFID registered for an access of the TCD, activate a command to unlock the TCD for access by the user.

### CROSS REFERNCE TO RELATED APPLICATIONS

This application claims priority to Provisional Patent Application No. 63/611,243 entitled “PRIVACY, SECURITY, AND MONITORING SYSTEM” filed on Dec. 18, 2023 and incorporated herein in its entirety.

### FIELD OF DISCLOSURE

The present disclosure generally relates to protection of a computing device, and more particularly, to RFID-based automated system and method for real-time monitoring and locking and unlocking of a computing device.

### BACKGROUND

Protecting a computing device from unauthorized access involves implementing several layers of security measures to safeguard data and functionality. Conventional applications use authentication methods including passwords for each device and account. Some systems use Multi-Factor Authentication (MFA) that combine something you know password with user smartphone data or user biometrics like fingerprints or facial recognition. The computing device operating system, applications, and firmware have to be updated regularly to protect against vulnerabilities.

As another layer of protection of a computing device, firewalls and Antivirus Software are used. Firewalls monitor and control incoming and outgoing traffic. Antivirus software is used to detect and mitigate malware threats. Encryption and VPNs are used to protect data and avoid using public Wi-Fi for sensitive activities.

Regularly change network passwords and ensure devices on the network are secured. User access to the computing device may be limited by administrative accounts designated only for system changes. A principle of least privilege (PoLP) to limit access rights for users and processes may be applied.

However, most common security measure is implementation of physical security of the computing device. The computing devices are locked when unattended using a password or biometric lock screen. Alerts for unauthorized login attempts or unusual activity may be set. Remote device management to locate, lock, or erase the device in case of loss or theft may be used. However, the existing approaches do not provide for a robust and simple defense against unauthorized access, protecting the computing devices and its data from unauthorized access and from malicious actors.

Accordingly, a system and method for RFID-based automated real-time monitoring, locking and unlocking of a computing device are desired.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

One embodiment of the present disclosure provides a system for real-time monitoring and managing access to a computing device including a processor of a target computing device (TCD) configured to host an integrated RFID module and connected to an RFID database and a memory on which are stored machine-readable instructions that when executed by the processor, cause the processor to: detect a user RFID tag by the integrated RFID module; derive a user RFID from a signal between the user RFID tag and the integrated RFID module; compare the RFID to the RFID database containing at least one RFID registered for an access to the TCD; and responsive to a match of the user RFID with the at least one RFID registered for an access of the TCD, activate a command to unlock the TCD for access by the user.

Another embodiment of the present disclosure provides a method that includes one or more of: detecting a user RFID tag by the integrated RFID module; deriving a user RFID from a signal between the user RFID tag and the integrated RFID module; comparing the RFID to the RFID database containing at least one RFID registered for an access to the TCD; and responsive to a match of the user RFID with the at least one RFID registered for an access of the TCD, activating a command to unlock the TCD for access by the user.

Another embodiment of the present disclosure provides a computer-readable medium including instructions for: detecting a user RFID tag by the integrated RFID module; deriving a user RFID from a signal between the user RFID tag and the integrated RFID module; comparing the RFID to the RFID database containing at least one RFID registered for an access to the TCD; and responsive to a match of the user RFID with the at least one RFID registered for an access of the TCD, activating a command to unlock the TCD for access by the user.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings may contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a network diagram of a system for RFID-based automated real-time monitoring, locking and unlocking of a computing device including detailed features of a target computing device (TCD) consistent with the present disclosure;

FIG. 2 illustrates a flowchart of a method for RFID-based automated real-time monitoring, locking and unlocking of a computing device consistent with the present disclosure;

FIG. 3 illustrates a further flowchart of a method for RFID-based automated real-time monitoring, locking and unlocking of a computing device consistent with the present disclosure;

FIG. 4 illustrates a block diagram of a system including a computing device for performing the method of FIGS. 2 and 3.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, itis to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 34 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of the RFID-based access to a computing system, embodiments of the present disclosure are not limited to use only in this context.

The following definitions may be used.

RFID-radio frequency identification that can be used to restrict physical access to a computing system or the room containing it. Only users with authorized RFID cards or badges can gain entry.

The RFID tag may be place on a user while RFID reader application may be installed on a computing system (e.g., PC, Laptop, Smartphone, Tablet, auto door actuator, etc.). The reader is operatively coupled to the processor of the computing system to allow locking and unlocking of the computing system based on detection of an RFID tag of an authorized user. A database of authorized RFID tags may be maintained for validation. In one embodiment, a blockchain ledger may be used for secure storage of the authorized RFID tags.

The present disclosure provides a system, method and computer-readable medium for RFID-based automated real-time monitoring, locking and unlocking of a computing device. In general, the embodiments herein relate to a privacy, security and monitoring system having an application program for electronic devices (e.g., computing devices, smartphones, laptops, etc.). The disclosed system creates a new layer of security using Radio Frequency Identification (RFID) technology which enables monitoring of the computing device.

The system increases the difficulty for others to access the target computing device and its information. In some embodiments, the target computing device includes an RFID device which emits radio waves at a predetermined distance (e.g., 4-feet). The RFID device may emit the radio signal through a sound system of the computing device that may be acknowledged by a relay microchip device or user RFID Tag which may be provided in a user remote device such as a credit-card like device, jewelry, pin, or other portable devices which is carried by the user. In some embodiments, the application program may be in operable communication with a web-based application via a network to permit users to access information on the computing device.

In one embodiment, to enhance this process, the system may integrate advanced technologies such as Artificial Intelligence (AI) and machine-learning (ML) and Blockchain. The AI may be leveraged for predicting access parameters when there is no clear reading of the user RFID Tag available.

Additionally, the disclosed system may incorporate Blockchain technology to ensure the transparency and immutability of transactions, providing a secure and trustworthy platform. By embedding these advanced technologies, the disclosed system for computing system access control, advantageously, offers a sophisticated and secure solution.

As discussed above, in one disclosed embodiment, the AI/ML technology may be combined with a blockchain technology for secure use of the access data (e.g., registered user RFID Tags). In one embodiment, a blockchain consensus may need to be implemented prior to provision of the final computing system access verdict for a user.

In one embodiment, target computing device (TCD) access-related documents and reports may be stored in a form of uniquely minted NFTs on the private (permissioned) blockchain ledger. In one embodiment, the ML module may use access predictive model(s) that use an artificial neural network (ANN) to generate computing device access parameters. The use of specially trained ANNs provides a number of improvements over traditional methods of access to the computing system, including more accurate prediction of the access parameters. The application further provides methods for training the ANN that leads to a more accurate predictive model(s).

In one embodiment, the ANN can be implemented by means of computer-executable instructions, hardware, or a combination of the computer-executable instructions and hardware. In one embodiment, neurons of the ANN may be represented by a register, a microprocessor configured to process input signals. Each neuron produces an output, or activation, based on an activation function that uses the outputs of the previous layer and a set of weights as inputs. Each neuron in a neuron array may be connected to another neuron via a synaptic circuit. A synaptic circuit may include a memory for storing a synaptic weight. A proposed ANN may be implemented as a Deep Neural Network having an input layer, an output layer, and several fully connected hidden layers. The proposed ANN may be particularly useful in production of the access parameters because the ANN can effectively extract features from the RFID-related data in linear and non-linear relationships. In some embodiments, the proposed ANN may be implemented by an application-specific integrated circuit (ASIC). The ASICs may be specially designed and configured for a specific AI application and provide superior computing capabilities and reduced electricity and computational resources consumption compared to the traditional CPUs.

In some embodiments, the application may operate in the absence of a network connection. In one embodiment, a conventional username-password authentication is replaced with RFID-based login. The computing system may be equipped with an RFID reader (USB or integrated). As discussed above, the user may have RFID-enabled smart cards or key fobs in miniaturized form. The system may be configured to authenticate users based on the RFID tag's unique ID. Optionally, the RFID may be paired with a second factor (e.g., PIN or biometrics) for two-factor authentication.

In one embodiment, passive RFID Tags may be used. The passive RFID Tags are the simplest RFID tags, only containing an integrated circuit and an antenna. These Tags do not transmit signals to readers, but rather engage when a reader sends a signal to the antenna. This is implemented through backscatter technology-without signals from the reader, the Tag remains inactive. If the Tag is located outside the reader's range, the tag will not have sufficient energy to send information to the reader. Because the Tag does not contain a battery, it lasts indefinitely.

The system, according to the disclosed embodiments, the application links to the internal sound system as it is downloaded to a target user device. The radio waves are emitted by the sound system of the target user device. Since the radio waves do not stop at a distance but just get weaker.

Therefore, very little power should be used by the transmitter (e.g., the electronic sound system of the computing device) as to ensure the signal stays as weak as possible since the distance used for disclosed embodiments is very short (about 6 feet and under). The band width needed for the disclosed embodiments is in a very low frequency range because of the short distance used for the user authentication.

In one embodiment, the disclosed system may employ encryption by encoding radio waves (audio signals) in such a way that only the target device and user Tag can access it, making eavesdropping and hacking very difficult.

There are two main types of encryption methods that may be used in this application—inversion scrambling and frequency hopping. Optionally, digital encryption may be used, but it is too complex for this civilian application. The primary encryption method used in the disclosed system, is the inversion scrambling.

The encryption module may invert the frequences in the entire range from 100 Hz to 100 KHz. However, mostly the range of 2.5 KHz-4.5 KHz is used. The encryption keys may be setup in the target device through encryption application or an encryption engine. In case of the encrypted RF signals, only device using the same frequencies and the same encryption keys within the effective distance range of the signal may be able to capture the transmission. The higher-frequency sounds or tones/harmonics in a signal are lowered in frequency while the lower-frequency tones are raised.

In one embodiment, the Frequency Scrambler software in the application uses a frequency value to invert the frequency of the input signal and provide a mirror image at a different frequency range. In a similar manner, inverted signals can be descrambled using the same frequency. Scrambling is a binary bit-level processing applied to the transmission rate of the signal in order to make the resulting binary signal sequence appear random.

Frequency inversion can be performed using a single frequency value in very short bursts, every 20 seconds, for example (three times every minute). For greater protection, inversion can use different frequencies that change periodically throughout the day. This allows for the implementation of a frequency hopping or rolling system using randomly generated frequencies or values selected from a predefined sequence of frequencies.

In one embodiment, the target computing device is locked automatically once the radio waves become too distant to be captured by the relay chip. This is the reason for using low frequency radio waves (or Wi-Fi, Bluetooth, etc.). In one embodiment, a frequency hopping method may be used as encryption means. In frequency hopping, signals rapidly hop from one frequency to another. Usually, the change occurs at predetermined intervals after a short burst of data.

A random sequence guides the process. The arrangement determines the order of frequency changes within the chosen bandwidth. The frequency hopping is unique because it does not scramble the message or code. Instead, the frequency hopping hides the message or code so eavesdroppers cannot intercept it. Also, the frequency hopping protects the system from intentional jamming and interference. Signals change their carrier frequency almost immediately. Hence, jamming and interference only happens for a short time. Whatever encryption method is used, the relay chip or user Tag may be programmed to read these specific radio waves. This transmission technique may be used in the discloses application for transmission of secret key codes only.

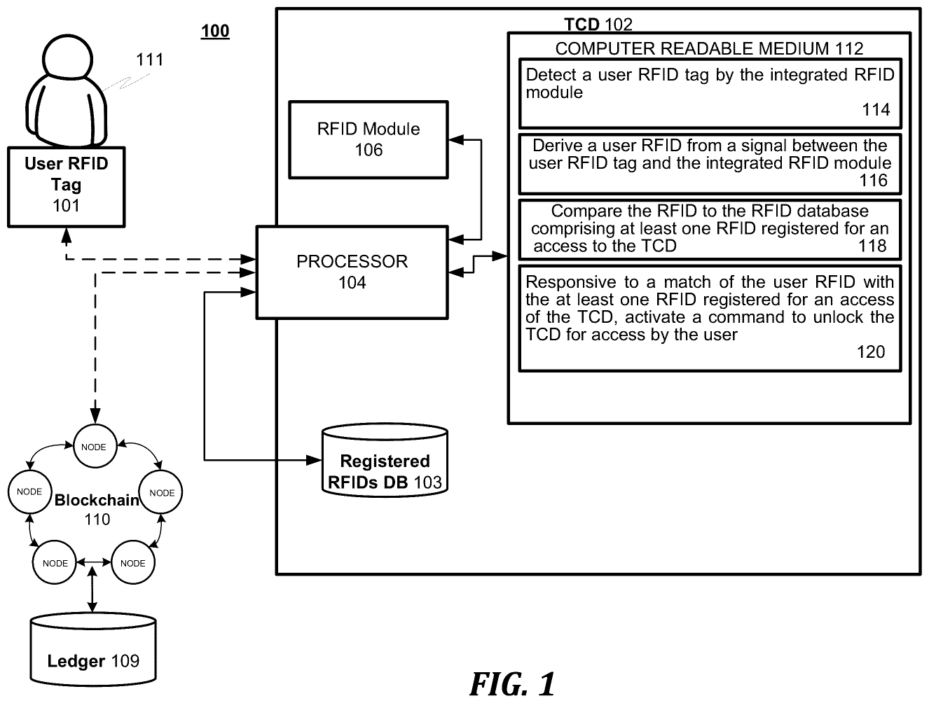

FIG. 1 illustrates a network diagram of a system for RFID-based automated real-time monitoring, locking and unlocking of a computing device including detailed features of a target computing device (TCD) consistent with the present disclosure.

The TCD 102 may detect a presence of a user RFID Tag 101 associated with the user 111. As discussed above, the user 111 may be authenticated to access the TCD 102 by verification of his RFID against a registered RFIDs database 103 or blockchain 110 ledger 109. If the user RFID Tag 101 is found among the registered RFIDs, the processor 104 of the TCD 102 generates a command to unlock the TCD 102 for the user 111.

Likewise, once the user 111 moves away from the TCD 102 to a position when the connection with his RFID Tag 101 and the TCD 102 is lost, the processor 104 of the TCD 102 activates a command to lock the TCD 102. The access log of the TCD 102 by the user 111 may be recorded on the ledger 109 of the blockchain 110. In one embodiment, the signal between the TCD 102 and the RFID Tag 101 may be encrypted. In this case, authentication of the user 111 may include decryption of the signal and deriving additional user verification features or access keys from the signal. An integrated RFID module 106 may be implemented on the TCD 102 and executed on the processor 104.

While this example describes in detail only one TCD 102, multiple such nodes may be connected to the network and to the blockchain 110. It should be understood that the TCD 102 may include additional components and that some of the components described herein may be removed and/or modified without departing from a scope of the TCD 102 disclosed herein. The TCD 102 may be a computing device or a server computer, or the like, and may include a processor 104, which may be a semiconductor-based microprocessor, a central processing unit (CPU), an application specific integrated circuit (ASIC), a field-programmable gate array (FPGA), and/or another hardware device. Although a single processor 104 is depicted, it should be understood that the TCD 102 may include multiple processors, multiple cores, or the like, without departing from the scope of the TCD 102 system.

The TCD 102 may also include a non-transitory computer readable medium 112 that may have stored thereon machine-readable instructions executable by the processor 204. Examples of the machine-readable instructions are shown as 114-120 and are further discussed below. Examples of the non-transitory computer readable medium 112 may include an electronic, magnetic, optical, or other physical storage device that contains or stores executable instructions. For example, the non-transitory computer readable medium 112 may be a Random-Access memory (RAM), an Electrically Erasable Programmable Read-Only Memory (EEPROM), a hard disk, an optical disc, or other type of storage device.

The processor 104 may fetch, decode, and execute the machine-readable instructions 114 to detect a user RFID tag 101 by the integrated RFID module 106. The processor 104 may fetch, decode, and execute the machine-readable instructions 116 to derive a user RFID from a signal between the user RFID tag 101 and the integrated RFID module 106. The processor 104 may fetch, decode, and execute the machine-readable instructions 118 to compare the RFID to the RFID database 103 containing at least one RFID registered for an access to the TCD 102. The processor 104 may fetch, decode, and execute the machine-readable instructions 120 to, responsive to a match of the user RFID with the at least one RFID registered for an access of the TCD 102, activate a command to unlock the TCD for access by the user.

As a non-limiting example, the consensual approval of the access report may be associated with verification of the user RFID Tag 101, etc. The permissioned blockchain 110 may be configured to use one or more smart contracts that manage transactions for multiple participating nodes and for recording the transactions on the ledger 109.

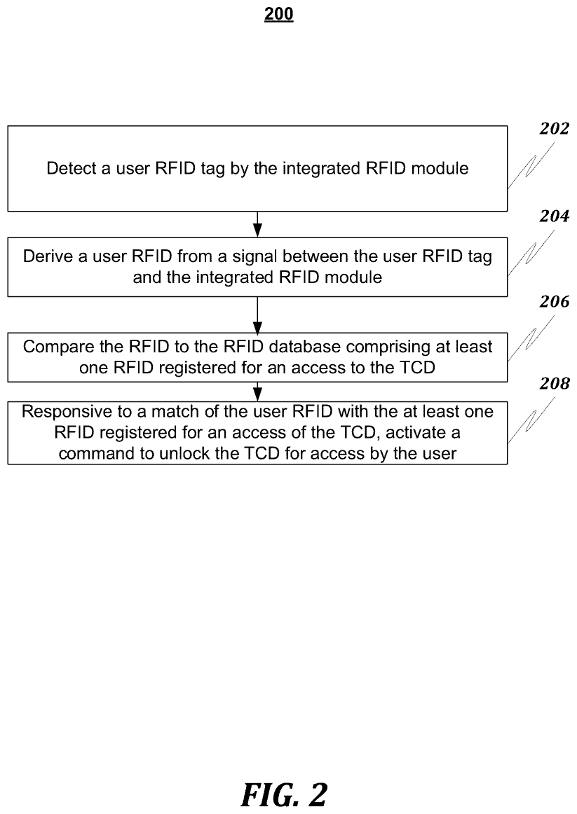

FIG. 2 illustrates a flowchart of a method for RFID-based automated real-time monitoring, locking and unlocking of a computing device consistent with the present disclosure.

FIG. 2 illustrates a flow chart of an example method executed by the TCD 102 (see FIG. 1). It should be understood that method 200 depicted in FIG. 2 may include additional operations and that some of the operations described therein may be removed and/or modified without departing from the scope of the method 200. The description of the method 200 is also made with reference to the features depicted in FIG. 1 for purposes of illustration. Particularly, the processor 104 of the TCD 102 may execute some or all of the operations included in the method 200.

With reference to FIG. 2, at block 202, the processor 104 may detect a user RFID tag by the integrated RFID module. At block 204, the processor 104 may derive a user RFID from a signal between the user RFID tag and the integrated RFID module.

At block 206, the processor 104 may compare the RFID to the RFID database comprising at least one RFID registered for an access to the TCD. At block 208, the processor 104 may, responsive to a match of the user RFID with the at least one RFID registered for an access of the TCD, activate a command to unlock the TCD for access by the user.

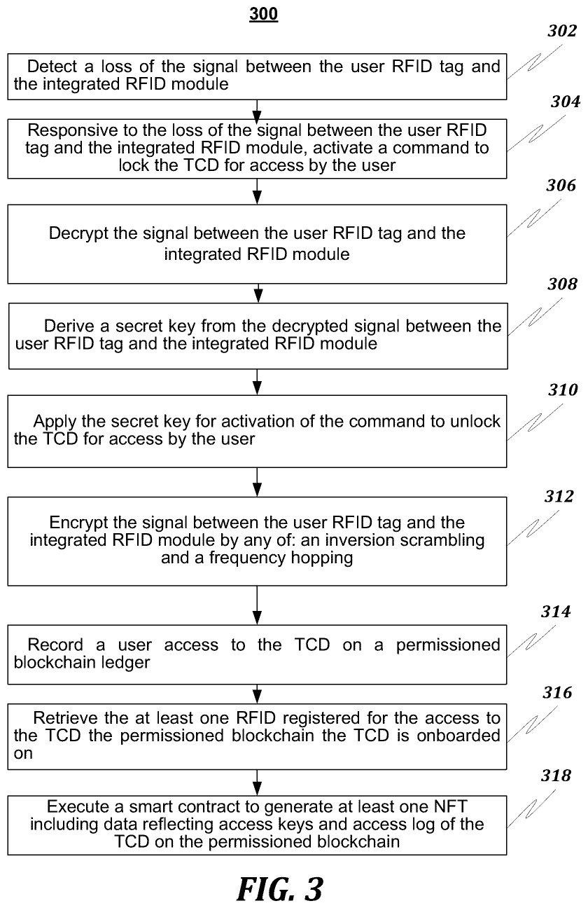

FIG. 3 illustrates a further flowchart of a method for RFID-based automated real-time monitoring, locking and unlocking of a computing device consistent with the present disclosure.

Referring to FIG. 3, the method 400 may include one or more of the steps described below. FIG. 3 illustrates a flow chart of an example method executed by the TCD 102 (see FIG. 1). It should be understood that method 300 depicted in FIG. 3 may include additional operations and that some of the operations described therein may be removed and/or modified without departing from the scope of the method 300. The description of the method 300 is also made with reference to the features depicted in FIG. 1 for purposes of illustration. Particularly, the processor 104 of the TCD 102 may execute some or all of the operations included in the method 400.

With reference to FIG. 3, at block 302, the processor 104 may detect a loss of the signal between the user RFID tag and the integrated RFID module. At block 304, the processor 104 may, responsive to the loss of the signal between the user RFID tag and the integrated RFID module, activate a command to lock the TCD for access by the user.

At block 306, the processor 104 may decrypt the signal between the user RFID tag and the integrated RFID module. At block 308, the processor 104 may derive a secret key from the decrypted signal between the user RFID tag and the integrated RFID module. At block 310, the processor 104 may apply the secret key for activation of the command to unlock the TCD for access by the user.

At block 312, the processor 104 may encrypt the signal between the user RFID tag and the integrated RFID module by any of: an inversion scrambling and a frequency hopping. At block 314, the processor 104 may record a user access to the TCD on a permissioned blockchain ledger. At block 316, the processor 104 may retrieve the at least one RFID registered for the access to the TCD the permissioned blockchain the TCD is onboarded on.

At block 318, the processor 104 may execute a smart contract to generate at least one NFT including data reflecting access keys and access log of the TCD on the permissioned blockchain.

In one embodiment, the TCD 102 may use a decentralized storage such as a blockchain 110 (see FIG. 1) that is a distributed storage system, which includes multiple nodes that communicate with each other. The decentralized storage includes an append-only immutable data structure resembling a distributed ledger capable of maintaining records between mutually untrusted parties. The untrusted parties are referred to herein as peers or peer nodes. Each peer maintains a copy of the parameter(s) records and no single peer can modify the records without a consensus being reached among the distributed peers. For example, the peers 111 and 102 (FIG. 1) may execute a consensus protocol to validate blockchain 110 storage transactions, group the storage transactions into blocks, and build a hash chain over the blocks. This process forms the ledger 109 by ordering the storage transactions, as is necessary, for consistency. In various embodiments, a permissioned and/or a permissionless blockchain can be used. In a public or permissionless blockchain, anyone can participate without a specific identity. Public blockchains can involve assets and use consensus based on various protocols such as Proof of Work (PoW). On the other hand, a permissioned blockchain provides secure interactions among a group of entities which share a common goal such as the computing device access parameters, but which do not fully trust one another.

This application utilizes a permissioned (private) blockchain that operates arbitrary, programmable logic, tailored to a decentralized storage scheme and referred to as “smart contracts” or “chaincodes.”

The permissioned blockchain is a type of blockchain network where participation is restricted to authorized entities. In the TCD 102, smart contracts may be used to automate the recording of device access parameters, updates of TCD 102 metrics, or generation of NFTs (Non-Fungible Tokens) that are unique digital assets on the blockchain representing ownership or proof of authenticity of a specific item(s). In the TCD 102 context, an NFT represents a unique user RFID Tag or access parameters or set of TCD metrics, providing a tamper-proof record of the verified user authentication and connection to the TCD 102.

In some cases, specialized chaincodes may exist on blockchain for management functions and parameters which are referred to as system chaincodes. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincodes to specify endorsers for a transaction in the form of a set of peer nodes that are necessary for endorsement. When a client sends the transaction to the peers specified in the endorsement policy, the transaction is executed to validate the transaction. After a validation, the transactions enter an ordering phase in which a consensus protocol is used to produce an ordered sequence of endorsed transactions grouped into blocks.

As discussed above, in one embodiment, the features and/or the actions described and/or depicted herein can occur on or with respect to the blockchain 110. The above embodiments of the present disclosure may be implemented in hardware, in computer-readable instructions executed by a processor, in firmware, or in a combination of the above. The computer computer-readable instructions may be embodied on a computer-readable medium, such as a storage medium. For example, the computer computer-readable instructions may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

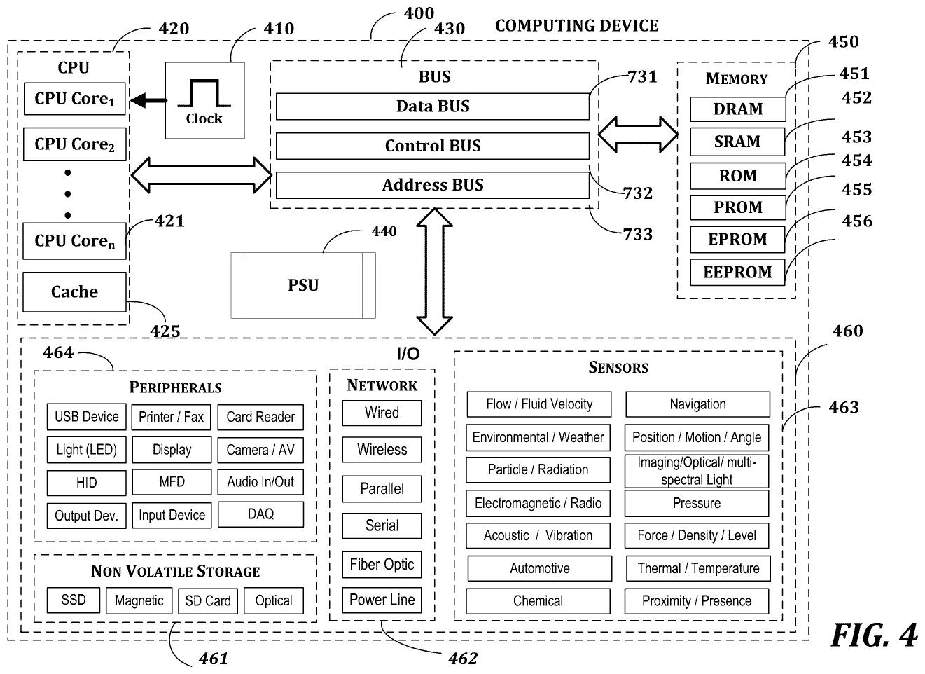

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative embodiment, the processor and the storage medium may reside as discrete components. For example, FIG. 4 illustrates an example computing device (e.g., a server node) 400, which may represent or be integrated in any of the above-described components, etc.

FIG. 4 illustrates a block diagram of a system including computing device 400. The computing device 400 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

The TCD 102 (see FIG. 1) may be hosted on a centralized server or on a cloud computing service. Although method 400 has been described to be performed by the TCD 102 implemented on a computing device 400, it should be understood that, in some embodiments, different operations may be performed by a plurality of the computing devices 400 in operative communication at least one network.

Embodiments of the present disclosure may comprise a computing device having a central processing unit (CPU) 420, a bus 430, a memory unit 440, a power supply unit (PSU) 440, and one or more Input/Output (I/O) units. The CPU 420 coupled to the memory unit 440 and the plurality of I/O units 460 via the bus 430, all of which are powered by the PSU 440. It should be understood that, in some embodiments, each disclosed unit may actually be a plurality of such units for the purposes of redundancy, high availability, and/or performance. The combination of the presently disclosed units is configured to perform the stages of any method disclosed herein.

Consistent with an embodiment of the disclosure, the aforementioned CPU 420, the bus 430, the memory unit 440, a PSU 440, and the plurality of I/O units 460 may be implemented in a computing device, such as computing device 400. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, the memory unit 440, consistent with embodiments of the disclosure.

At least one computing device 400 may be embodied as any of the computing elements illustrated in all of the attached figures, including the AES node 102 (FIG. 2). A computing device 400 does not need to be electronic, nor even have a CPU 420, nor bus 430, nor memory unit 440. The definition of the computing device 400 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 4, a system consistent with an embodiment of the disclosure may include a computing device, such as computing device 400. In a basic configuration, computing device 400 may include at least one clock module 410, at least one CPU 420, at least one bus 430, and at least one memory unit 440, at least one PSU 440, and at least one I/O 460 module, wherein I/O module may be comprised of, but not limited to a non-volatile storage sub-module 461, a communication sub-module 462, a sensors sub-module 463, and a peripherals sub-module 464.

A system consistent with an embodiment of the disclosure the computing device 400 may include the clock module 410 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 420, the central component of modern computers, which relies on a clock. The only exceptions are asynchronous circuits such as asynchronous CPUs. The clock 410 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 400 use a “clock multiplier” which multiplies a lower frequency external clock to the appropriate clock rate of the CPU 420. This allows the CPU 420 to operate at a much higher frequency than the rest of the computer, which affords performance gains in situations where the CPU 420 does not need to wait on an external factor (like memory 440 or input/output 460). Some embodiments of the clock 410 may include dynamic frequency change, where the time between clock edges can vary widely from one edge to the next and back again.

A system consistent with an embodiment of the disclosure the computing device 400 may include the CPU unit 420 comprising at least one CPU Core 421. A plurality of CPU cores 421 may comprise identical CPU cores 421, such as, but not limited to, homogeneous multi-core systems. Itis also possible for the plurality of CPU cores 421 to comprise different CPU cores 421, such as, but not limited to, heterogeneous multi-core systems, big.LITTLE systems and some AMD accelerated processing units (APU). The CPU unit 420 reads and executes program instructions which may be used across many application domains, for example, but not limited to, general purpose computing, embedded computing, network computing, digital signal processing (DSP), and graphics processing (GPU). The CPU unit 420 may run multiple instructions on separate CPU cores 421 at the same time. The CPU unit 420 may be integrated into at least one of a single integrated circuit die and multiple dies in a single chip package. The single integrated circuit die and multiple dies in a single chip package may contain a plurality of other aspects of the computing device 400, for example, but not limited to, the clock 410, the CPU 420, the bus 430, the memory 440, and I/O 460.

The CPU unit 420 may contain cache 422 such as, but not limited to, a level 1 cache, level 2 cache, level 3 cache or combination thereof. The aforementioned cache 422 may or may not be shared amongst a plurality of CPU cores 421. The cache 422 sharing comprises at least one of message passing and inter-core communication methods may be used for the at least one CPU Core 421 to communicate with the cache 422. The inter-core communication methods may comprise, but not limited to, bus, ring, two-dimensional mesh, and crossbar. The aforementioned CPU unit 420 may employ symmetric multiprocessing (SMP) design.

The plurality of the aforementioned CPU cores 421 may comprise soft microprocessor cores on a single field programmable gate array (FPGA), such as semiconductor intellectual property cores (IP Core). The plurality of CPU cores 421 may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the aforementioned computing device 400, and/or the plurality of computing devices 400. The aforementioned communication system will be known to a person having ordinary skill in the art as a bus 430. The bus 430 may embody internal and/or external plurality of hardware and software components, for example, but not limited to a wire, optical fiber, communication protocols, and any physical arrangement that provides the same logical function as a parallel electrical bus. The bus 430 may comprise at least one of, but not limited to a parallel bus, wherein the parallel bus carry data words in parallel on multiple wires, and a serial bus, wherein the serial bus carry data in bit-serial form. The bus 430 may embody a plurality of topologies, for example, but not limited to, a multidrop/electrical parallel topology, a daisy chain topology, and a connected by switched hubs, such as USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect extended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and extensible Host Controller Interface (xHCI).

Consistent with the embodiments of the present disclosure, the aforementioned computing device 400 may employ hardware integrated circuits that store information for immediate use in the computing device 400, known to the person having ordinary skill in the art as primary storage or memory 440. The memory 440 operates at high speed, distinguishing it from the non-volatile storage sub-module 461, which may be referred to as secondary or tertiary storage, which provides slow-to-access information but offers higher capacities at lower cost. The contents contained in memory 440, may be transferred to secondary storage via techniques such as, but not limited to, virtual memory and swap. The memory 440 may be associated with addressable semiconductor memory, such as integrated circuits consisting of silicon-based transistors, used for example as primary storage but also other purposes in the computing device 400. The memory 440 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 441, Static Random-Access Memory (SRAM) 442, CPU Cache memory 424, Advanced Random-Access Memory (A-RAM), and other types of primary storage such as Random-Access Memory (RAM).
Non-volatile memory which can retain stored information even after power is removed, for example, but not limited to, Read-Only Memory (ROM) 443, Programmable ROM (PROM) 444, Erasable PROM (EPROM) 444, Electrically Erasable PROM (EEPROM) 446 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).
Consistent with the embodiments of the present disclosure, the aforementioned computing device 400 may employ the communication system between an information processing system, such as the computing device 400, and the outside world, for example, but not limited to, human, environment, and another computing device 400. The aforementioned communication system will be known to a person having ordinary skill in the art as I/O 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces a plurality of hardware, such as, but not limited to, non-volatile storage 461, communication devices 462, sensors 463, and peripherals 464. The plurality of hardware is used by at least one of, but not limited to, human, environment, and another computing device 400 to communicate with the present computing device 400. The I/O module 460 may comprise a plurality of forms, for example, but not limited to channel I/O, port mapped I/O, asynchronous I/O, and Direct Memory Access (DMA).
Consistent with the embodiments of the present disclosure, the aforementioned computing device 400 may employ the non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using an intermediate area in the memory 440. The non-volatile storage sub-module 461 does not lose data when power is removed and may be two orders of magnitude less costly than storage used in memory modules, at the expense of speed and latency. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD+RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 400 may employ the communication sub-module 462 as a subset of the I/O 460, which may be referred to by a person having ordinary skill in the art as at least one of, but not limited to, computer network, data network, and network. The network allows computing devices 400 to exchange data using connections, which may be known to a person having ordinary skill in the art as data links, between network nodes. The nodes comprise network computer devices 400 that originate, route, and terminate data. The nodes are identified by network addresses and can include a plurality of hosts consistent with the embodiments of a computing device 400. The aforementioned embodiments include, but not limited to personal computers, phones, servers, drones, and networking devices such as, but not limited to, hubs, switches, routers, modems, and firewalls.

Two nodes can be networked together, when one computing device 400 is able to exchange information with the other computing device 400, whether or not they have a direct connection with each other. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 462 may comprise a plurality of size, topology, traffic control mechanism and organizational intent. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Cellular systems embody technologies such as, but not limited to, 3G, 4G (such as WiMax and LTE), and 4G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line and wireless communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 400 may employ the sensors sub-module 463 as a subset of the I/O 460. The sensors sub-module 463 comprises at least one of the devices, modules, and subsystems whose purpose is to detect events or changes in its environment and send the information to the computing device 400. Sensors are sensitive to the measured property, are not sensitive to any property not measured, but may be encountered in its application, and do not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:

Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nano-sensors).

Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermos-luminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, LiDAR, multi-spectral light sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photo-switch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezo capacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ the peripherals sub-module 462 as a subset of the I/O 460. The peripheral sub-module 464 comprises ancillary devices used to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 400. Output devices convert electronically generated information into a form that can be presented to humans. Input/output devices that perform both input and output functions. It should be understood by a person having ordinary skill in the art that the ensuing are non-limiting embodiments of the aforementioned peripheral sub-module 464:

### Input Devices

Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
High degree of freedom devices, that require up to six degrees of freedom such as, but not limited to, camera gimbals, Cave Automatic Virtual Environment (CAVE), and virtual reality systems.
Video Input devices are used to digitize images or video from the outside world into the computing device 400. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
Audio input devices are used to capture sound. In some cases, an audio output device can be used as an input device, in order to capture produced sound. Audio input devices allow a user to send audio signals to the computing device 400 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrument Digital Interface (MIDI) devices such as, but not limited to a keyboard, and headset.
Data Acquisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).

Output Devices may further comprise, but not be limited to:
Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).

Printers, such as, but not limited to, inkjet printers, laser printers, 3D printers, solid ink printers and plotters.
Audio and Video (AV) devices, such as, but not limited to, speakers, headphones, amplifiers and lights, which include lamps, strobes, DJ lighting, stage lighting, architectural lighting, special effect lighting, and lasers.
Other devices such as Digital to Analog Converter (DAC)

Input/Output Devices may further comprise, but not be limited to, touchscreens, networking device (e.g., devices disclosed in network 462 sub-module), data storage device (non-volatile storage 461), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for real-time monitoring and managing access to a computing device, comprising:
a processor of a target computing device (TCD) configured to host an integrated RFID module and connected to an RFID database; and
a memory on which are stored machine-readable instructions that when executed by the processor, cause the processor to:
detect a user RFID tag by the integrated RFID module;
derive a user RFID from a signal between the user RFID tag and the integrated RFID module;
compare the RFID to the RFID database comprising at least one RFID registered for an access to the TCD; and
responsive to a match of the user RFID with the at least one RFID registered for an access of the TCD, activate a command to unlock the TCD for access by the user.

2. The system of claim 1, wherein the machine-readable instructions that when executed by the processor, cause the processor to detect a loss of the signal between the user RFID tag and the integrated RFID module.

3. The system of claim 2, wherein the machine-readable instructions that when executed by the processor, cause the processor to, responsive to the loss of the signal between the user RFID tag and the integrated RFID module, activate a command to lock the TCD for access by the user.

4. The system of claim 1, wherein the machine-readable instructions that when executed by the processor, cause the processor to decrypt the signal between the user RFID tag and the integrated RFID module.

5. The system of claim 4, wherein the machine-readable instructions that when executed by the processor, cause the processor to derive a secret key from the decrypted signal between the user RFID tag and the integrated RFID module.

6. The system of claim 5, wherein the machine-readable instructions that when executed by the processor, cause the processor to apply the secret key for activation of the command to unlock the TCD for access by the user.

7. The system of claim 1, wherein the machine-readable instructions that when executed by the processor, cause the processor to encrypt the signal between the user RFID tag and the integrated RFID module by any of: an inversion scrambling and a frequency hopping.

8. The system of claim 1, wherein the machine-readable instructions that when executed by the processor, further cause the processor to record a user access to the TCD on a permissioned blockchain ledger.

9. The system of claim 8, wherein the machine-readable instructions that when executed by the processor, further cause the processor to retrieve the at least one RFID registered for the access to the TCD the permissioned blockchain the TCD is onboarded on.

10. The system of claim 9, wherein the machine-readable instructions that when executed by the processor, further cause the processor to execute a smart contract to generate at least one NFT including data reflecting access keys and access log of the TCD on the permissioned blockchain.

11. A method for a real-time monitoring and managing access to a computing device, comprising:
detecting a user RFID tag by an integrated RFID module of a target computing device (TCD);
deriving, by the TCD, a user RFID from a signal between the user RFID tag and the integrated RFID module;
comparing, by the TCD, the RFID to the RFID database comprising at least one RFID registered for an access to the TCD; and
responsive to a match of the user RFID with the at least one RFID registered for an access of the TCD, activating, by the TCD, a command to unlock the TCD for access by the user.

12. The method of claim 11, further comprising detecting a loss of the signal between the user RFID tag and the integrated RFID module.

13. The method of claim 12, further comprising, responsive to the loss of the signal between the user RFID tag and the integrated RFID module, activating a command to lock the TCD for access by the user.

14. The method of claim 11, further comprising decrypting the signal between the user RFID tag and the integrated RFID module.

15. The method of claim 14, further comprising deriving a secret key from the decrypted signal between the user RFID tag and the integrated RFID module.

16. The method of claim 15, further comprising applying the secret key for activation of the command to unlock the TCD for access by the user.

17. The method of claim 11, further comprising encrypting the signal between the user RFID tag and the integrated RFID module by any of: an inversion scrambling and a frequency hopping.

18. The method of claim 11, further comprising recording a user access to the TCD on a permissioned blockchain ledger.

19. The method of claim 18, further comprising retrieving the at least one RFID registered for the access to the TCD from the permissioned blockchain the TCD is onboarded on.

20. A non-transitory computer-readable medium comprising instructions, that when read by a processor, cause the processor to perform:
detecting a user RFID tag by an integrated RFID module of a target computing device (TCD);
deriving a user RFID from a signal between the user RFID tag and the integrated RFID module;
comparing the RFID to the RFID database comprising at least one RFID registered for an access to the TCD; and
responsive to a match of the user RFID with the at least one RFID registered for an access of the TCD, activating a command to unlock the TCD for access by the user.
